(19) United States
(12) Patent Application Publication
(10) Pub. No.: US 2022/0084384 A1
(43) Pub. Date: Mar. 17, 2022

(54) METHOD AND APPARATUS FOR DETECTING CHILD STATUS, ELECTRONIC DEVICE, AND STORAGE MEDIUM

(71) Applicant: Shanghai Sense Time Lingang Intelligent Technology Co, Ltd., Shanghai (CN)

(72) Inventors: Fei WANG, Shanghai (CN); Chen QIAN, Shanghai (CN)

(21) Appl. No.: 17/536,802

(22) Filed: Nov. 29, 2021

Related U.S. Application Data
(63) Continuation of application No. PCT/CN2020/136250, filed on Dec. 14, 2020.

(30) Foreign Application Priority Data
Mar. 30, 2020 (CN) 202010239259.7

(51) Int. Cl. G08B 21/02; G06V 20/59; G06V 40/10; G06V 40/16; G06V 40/18; G06V 10/82; G06T 7/70; B60W 40/08; B60W 40/105; B60W 50/00; G06N 3/02

(52) U.S. Cl. CPC G08B 21/02; B60W 2540/229; G06V 40/103; G06V 40/171; G06V 40/172; G06V 40/176; G06V 40/18; G06V 10/82; G06T 7/70; B60W 40/08; B60W 40/105; B60W 50/0098; G06N 3/02; G06T 2207/20021; G06T 2207/20084; G06T 2207/30201; G06T 2207/30268; B60W 2040/0881; B60W 2540/227; G06V 20/593

(57) ABSTRACT

A method and apparatus for detecting child status, an electronic device, and a computer-readable storage medium are provided. A target picture of an interior of a vehicle cabin is acquired firstly. After that, a child in the target picture is identified. Whether the child is located on a rear seat in the vehicle cabin is determined based on position information of the child. Finally, in a case where the child is not located on the rear seat in the vehicle cabin, an alarm is issued.

### CROSS-REFERENCE TO RELATED APPLICATIONS

This is a continuation application of International Patent Application No. PCT/CN2020/136250, filed on Dec. 14, 2020, which is based on and claims priority to Chinese Patent Application No. 202010239259.7, filed on Mar. 30, 2020. The entire contents of International Patent Application No. PCT/CN2020/136250 and Chinese Patent Application No. 202010239259.7 are incorporated herein by reference in their entireties.

### BACKGROUND

The current automotive electronics industry is developing rapidly, a convenient and comfortable vehicle cabin environment is provided for people to ride on the vehicle. Vehicle cabin intelligentization and safety is an important development direction of current automobile industry.

Children are at greater risk of riding on the vehicle due to limitations such as physical development. In the safety perception aspect of the vehicle-mounted system, at present, the safety of a child riding on a vehicle cannot be effectively recognized and warned, resulting in a problem in the safety aspect of the child riding on a vehicle.

### SUMMARY

The present disclosure relates to the technical field of computer vision, and in particular to a method and an apparatus for detecting child status, an electronic device, and a computer readable storage medium.

In view of the above, the present disclosure provides at least a method and an apparatus for detecting child status.

In the first aspect, the present disclosure provides a method for detecting child status. The method includes the following operations.

A target picture of an interior of a vehicle cabin is acquired.

A child in the target picture is identified.

Whether the child is located on a rear seat in the vehicle cabin is determined based on position information of the child.

In a case where the child is not located on the rear seat in the vehicle cabin, an alarm is issued.

In the second aspect, the present disclosure provides an apparatus detecting child status. The apparatus includes a picture acquisition module, a child identification module, a position determination module and an alarm module.

The picture acquisition module is configured to acquire a target picture of an interior of a vehicle cabin.

A child identification module is configured to identify a child in the target picture.

A position determination module is configured to determine, based on position information of the child, whether the child is located on a rear seat in the vehicle cabin;

An alert module is configured to issue an alarm in a case where the child is not located on the rear seat in the vehicle cabin.

In the third aspect, the present disclosure provides an electronic device. The electronic device includes a processor, a memory, and a bus, the memory storing machine-readable instructions executable by the processor, the processor communicating with the memory through the bus when the electronic device is operating, the processor executes the machine-readable instructions to perform the steps of above method for detecting child status.

In the fourth aspect, the present disclosure further provides a computer-readable storage medium on which computer programs are stored, and when the computer programs are executed by a processor, the steps of the above method for detecting child status are performed.

The present disclosure provides a computer program product including computer readable code. When the computer readable code is executed by an electronic device, a processor in the electronic device performs the methods in the above one or more embodiments.

The apparatus, the electronic device, and the computer-readable storage medium of the present disclosure include at least substantially the same or similar technical features as those of any aspect or any embodiment of the method of the present disclosure. Therefore, the effect description of the apparatus, the electronic device, and the computer-readable storage medium may refer to the effect description of the content of the above method, and details are not described herein.

### BRIEF DESCRIPTION OF THE DRAWINGS

In order to more clearly illustrate the technical solutions of the embodiments of the present disclosure, the following will briefly introduce the drawings needed in the embodiments. It should be understood that the following drawings show only certain embodiments of the present disclosure and should not be regarded as limiting the scope thereof. Other relevant drawings may be obtained according to these drawings without creative effort by those of ordinary skill in the art.

FIG. 1 shows a flowchart of a method for detecting child status according to some embodiments of the present disclosure.

FIG. 2 shows a flowchart of determining object information of various objects in the target picture in another method for detecting child status according to some embodiments of the present disclosure.

FIG. 3 shows a flowchart of determining object type information in another method for detecting child status according to some embodiments of the present disclosure.

FIG. 4 shows a flowchart of determining emotional status characteristic information of the identified child in another method for detecting child status according to some embodiments of the present disclosure.

FIG. 5 shows a schematic structural diagram of an apparatus for detecting child status according to some embodiments of the present disclosure.

FIG. 6 shows a schematic structural diagram of an electronic device according to the embodiments of the present disclosure.

### DETAILED DESCRIPTION

In order to make the objectives, technical solutions and advantages of the embodiments of the present disclosure more clear, the technical solutions of the embodiments of the present disclosure will be described in detail below in conjunction with the accompanying drawings in the embodiments of the present disclosure. It should be understood that the accompanying drawings of the present disclosure are only for the purposes of description and are not intended to limit the scope of protection of the present disclosure. In addition, it should be understood that the schematic drawings are not drawn to physical scale. The flowcharts used in the present disclosure illustrate operations implemented in accordance with some embodiments of the present disclosure. It should be understood that the operations of the flowchart may not be implemented in order, and steps without logical context relationships may be implemented in reverse order or simultaneously. In addition, one skilled in the art, guided by the content of present disclosure, may add one or more other operations to the flowchart, or may remove one or more operations from the flowchart.

In addition, the described embodiments are only some but not all of the embodiments of the present disclosure. The components of embodiments of the present disclosure, which are generally described and illustrated herein, may be arranged and designed in various different configurations. Accordingly, the following detailed description of embodiments of the disclosure provided in the accompanying drawings is not intended to limit the scope of the disclosure as claimed, but merely represents selected embodiments of the disclosure. Based on embodiments of the present disclosure, all other embodiments obtained by those skilled in the art without creative effort fall within the scope of the present disclosure.

It should be noted that the term “comprising” will be used in embodiments of the present disclosure to indicate the presence of features declared later, but not rule out to add other features.

The present disclosure provides a method and an apparatus for detecting child status, an electronic device, and a computer-readable storage medium. According to the present disclosure, whether a child in a vehicle cabin is located on a rear seat is determined by identifying the child in the vehicle cabin and the position of the child, and an alarm is issued in a case where the child is not located on the rear seat, thereby effectively improving an accuracy rate of safety status identification when the child is riding on a vehicle, and improving safety of the child riding on a vehicle.

The following describes a method and an apparatus for detecting child status, an electronic device, and a computer-readable storage medium of the present disclosure by embodiments.

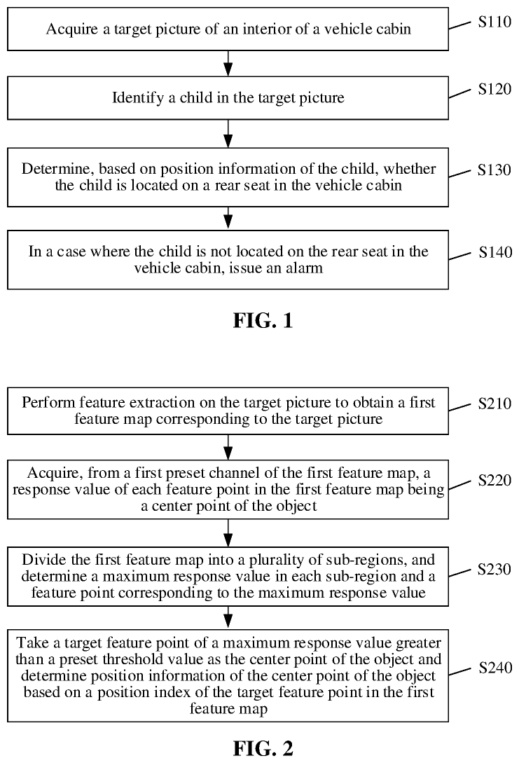

Embodiments of the present disclosure provide a method for detecting child status. The method is applied to a terminal device, a server, or the like that detects status and safety of a child. As shown in FIG. 1, the method for detecting child status provided by some embodiments of the present disclosure includes the following steps.

In step S110,a target picture of an interior of a vehicle cabin is acquired.

Here, the target picture may or may not include a child, and the picture may be photographed by a terminal device that detects the status and safety of the child, or may be photographed by another photographing device and transmitted to the terminal device or the server that detects the status and safety of the child.

In step S120, a child in the target picture is identified.

Here, the operation that the child in the target picture is identified includes screening out a child from various objects in the target picture, and determining position information of the child.

When a child in the target picture is identified, object information of various objects in the target picture may be firstly determined based on the target picture. The object information of one object includes center point information of the object and object type information corresponding to the center point of the object. Then, the child in the target picture is determined based on the determined object information of various objects.

The above object type information may include a child type, a rear seat type, a safety seat type, an adult type, and the like. The center point information may include position information of a center point of a corresponding object. In this way, in the implementation, a child may be screened out from various objects in the target picture by using the object type information corresponding to the determined center point, and then the position information of the child may be determined by using the center point information belonging to the child.

In this step, by identifying and determining the center point of the object and the object type information corresponding to the center point, the child in the target picture can be identified accurately, and the accuracy rate of the child identification in the target picture is improved.

In step S130, whether the child is located on a rear seat in the vehicle cabin is determined based on the position information of the child.

Here, before determining whether the child is located on the rear seat in the vehicle cabin, the rear seat in the target picture is needed to be identified and the position information of the rear seat is needed to be determined firstly.

The method of identifying the rear seat in the target picture and the method of determining the position information of the rear seat are the same as those described above for identifying a child in the target picture and determining the position information of the child. That is, the rear seat may be screened out from various objects in the target picture by using the object type information corresponding to the determined center point, and then the position information of the rear seat may be determined by using the center point information belonging to the rear seat.

After determining the position information of the child and the position information of the rear seat, whether the child is located on the rear seat in the vehicle cabin by using the two position information.

In step S140, in a case where the child is not located on the rear seat in the vehicle cabin, an alarm is issued.

Here, when it is determined that the child is not on the rear seat, the riding status of the child is unsafe, and an alarm may be issued to the driver or other passengers to correct the position of the child in the vehicle cabin, thereby improving the safety of the child riding on a vehicle.

In order to further improve the safety of the child during riding on a vehicle, the child should be located not only on the rear seat but also on the safety seat. Therefore, the above method for detecting child status may further include the following steps.

Whether the child is located on a safety seat is determined based on position information of the child and position information of the safety seat in the target picture. In a case where the child is not located on the safety seat, an alarm is issued in response to the movement speed of the vehicle cabin being greater than a preset value.

Before performing the above steps, the safety seat in the target picture is needed to be identified firstly, and the position information of the safety seat is determined in a case where there is a safety seat in the vehicle cabin.

The method of identifying the safety seat in the target picture and the method of determining the position information of the safety seat are the same as the method described above for identifying a child in the target picture and determining the position information of the child. That is, the safety seat may be screened out from various objects in the target picture by using the object type information corresponding to the determined center point, and then the position information of the safety seat may be determined by using the center point information belonging to the safety seat.

After determining the position information of the child and the position information of the safety seat, whether the child is located on the safety seat in the vehicle cabin may be determined by using the two position information.

If, by identification, it is determined that there is no safety seat in the vehicle cabin, an alarm is issued in response to the movement speed of the vehicle cabin being greater than a preset value in a case of determining that there is no safety seat in the vehicle cabin. In this way, in a case where there is no safety seat in the vehicle cabin in the scene of child riding on a vehicle, an alarm can be issued in time to improve the safety of the child riding on a vehicle.

When the child is not located on the safety seat and the movement speed of the vehicle cabin is greater than a preset value, an alarm is issued, which further improves the accuracy rate of the safety status identification when the child is riding on the vehicle, and improves the safety of the child riding on the vehicle.

In the above embodiments, the child, the rear seat, the safety seat, and the like may be identified and positioned according to the object information. The above object may be a human face, a human body, a rear seat, a safety seat, or the like.

Then, as shown in FIG. 2, in some embodiments, the object information of various objects in the target picture may be determined by using the following steps.

In step S210, feature extraction is performed on the target picture to obtain a first feature map corresponding to the target picture.

Here, the target picture may be input into a neural network for picture feature extraction, for example, the target picture is input into a backbone neural network for picture feature extraction to obtain an initial feature map. The initial feature map is then input to a neural network used for object information extraction to obtain the above first feature map.

In the implementation, the above target picture may be a picture with a size of 640×480 pixel, and an initial feature map with 80×60×C may be obtained after backbone processing. Where, C represents the number of channels. After the initial feature map is processed by the neural network used for object information extraction, a first feature map with 80×60×3 may be obtained.

In step S220, a response value of each feature point in the first feature map being a center point of the object is acquired from a first preset channel of the first feature map.

Here, the first preset channel may be the 0th channel in the first feature map, which is the channel of the center point of the object, and the response value in the channel may represent the possibility of each feature point being the center point of the object.

After the response values corresponding to the various feature points in the first preset channel are acquired, the response values may be converted to values between zero and one by using the sigmoid activation function.

In step S230, the first feature map is divided into a plurality of sub-regions, and a maximum response value in each sub-region and a feature point corresponding to the maximum response value are determined.

Here, a maximum pooling operation of 3×3 with the step-size being 1 may be performed on the feature map to obtain a maximum response value within the 3×3 and its position index on the first feature map. That is, 60×80 maximum response values and their corresponding positions index may be acquired.

Then, the same position index may be combined to obtain N maximum response values, a position index corresponding to each maximum response value, and a feature point corresponding to each maximum response value.

In step S240, the target feature point of a maximum response value greater than a preset threshold value is taken as the center point of the object, and the position information of the center point of the object is determined based on the position index of the target feature point in the first feature map.

Here, a threshold value third may be preset, and when the maximum response value is greater than third, it is determined that the feature point is the center point of the object.

As described above, by performing the maximum pooling processing on the response values in the feature map, the feature point that is most likely to be the center point of the target in the local range can be found, thereby effectively improving the accuracy rate of the determined center point.

As described above, the center point of the object and the position information of the center point are used as the center point information. In some embodiments, the object information may further include length information and width information of the center point of the object. At this time, the length information and the width information of the center point may be determined by using the following steps.

The length information of an object taking the target feature point as the center point of the object is acquired at the position corresponding to the position index of the target feature point form the second preset channel of the first feature map. The width information of an object taking the target feature point as the center point of the object is acquired at the position corresponding to the position index of the target feature point from a third preset channel of the first feature map.

The above second preset channel may be the first channel in the first feature map, and the above third preset channel may be the second channel in the first feature map. In the above step, the length information of the center point is acquired at the position corresponding to the center point from the first channel in the first feature map, and the width information of the center point is acquired at the position corresponding to the center point from the second channel in the first feature map.

After the center point of the object is determined, the length information and the width information of the center point of the object can be accurately acquired from the other preset channels in the feature map by using the position index of the center point.

Since the object may be a face, a human body, a rear seat, a safety seat, or the like, in the implementation, the first feature maps corresponding to different objects are needed to be determined by using different neural networks, and then center points of different objects, position information of each center point, length information of each center point, and width information of each center point are determined based on the different first feature maps.

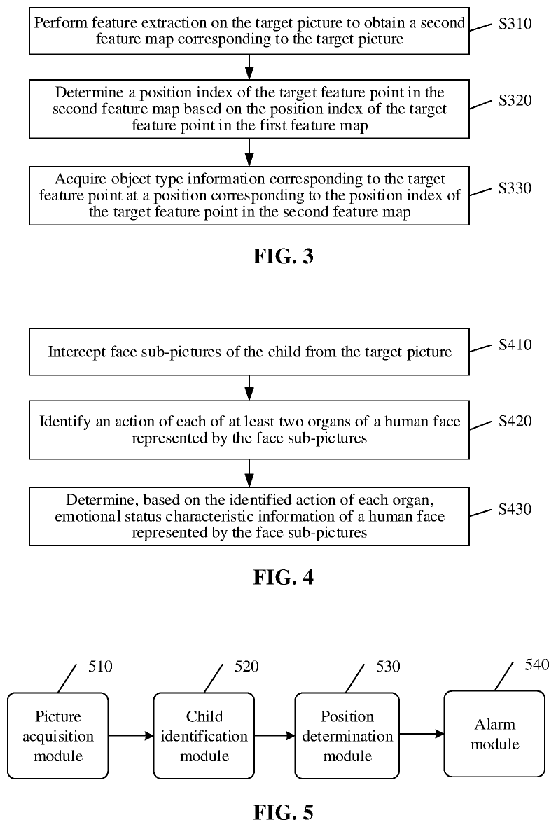

As can be seen from the above statement, the object information includes object type information corresponding to the center point of the object. In some embodiments, as shown in FIG. 3, the object type information may be determined by using the following steps.

In step S310, feature extraction is performed on the target picture to obtain a second feature map corresponding to the target picture.

Here, the target picture may be input into a neural network for picture feature extraction, for example, the target picture is input into a backbone neural network for picture feature extraction to obtain an initial feature map, and then the initial feature map is input into the neural network used for object type identification for processing to obtain a second feature map, and the object type information corresponding to the center point of each object can be determined based on the second feature map. The above second feature map may be a 80×60×2 feature map.

In the application scenario of identifying a child, each feature point in the second feature map corresponds to a two-dimensional feature vector, and a classification result may be acquired by performing classification process on a two-dimensional feature vector on the feature point in the second feature map corresponding to the center point of object. In a case where one classification result represents the child and the other classification result represents other type, whether the object type information of the center point object is the child may be determined based on the above classification result. In an application scenario of identifying a child, the above object may be a human body or a human face.

In an application scenario in which the safety seat is identified, each feature point in the second feature map corresponds to a two-dimensional feature vector, and a classification result may be acquired by performing classification process on a two-dimensional feature vector on the feature point in the second feature map corresponding to the center point of object. In a case where one classification result represents the safety seat and the other classification result represents other type, whether the object type information of the center point object is the safety seat may be determined based on the above classification result.

Of course, the rear seats and the like may be identified by the same method.

Since the object may be a human face, a human body, a rear seat, a safety seat, or the like, in the implementation, the second feature maps corresponding to different objects are needed to be determined by using different neural networks, and then object type information of the different objects is determined based on the different second feature maps.

In step S320, the position index of the target feature point in the second feature map is determined based on the position index of the target feature point in the first feature map.

Here, the target feature point is the center point of the object. The target feature point is a feature point corresponding to a maximum response value greater than the preset threshold value.

In step S330, object type information corresponding to the target feature point is acquired at the position corresponding to the position index of the target feature point in the second feature map.

After the center point of the object is determined, the object type information corresponding to the center point of the object can be accurately acquired by using the position index of the center point.

In the application scenario for identifying a child, after the object type information corresponding to the center points of various objects is determined, the child in the target picture may be identified by using the following steps.

In the first step, predicted position information of a center point of a respective human face matching each human body is determined respectively based on the position offset information corresponding to the center point of each human body. The human body and human face belonging to a same person are matched with each other.

Before performing this step, the position offset information of the center point of each human body and the center point of the human face belonging to the same person is needed to be determined firstly, and then the predicted position information is determined by using the position offset information.

In determining the above position offset information, the target picture may be input into a neural network for picture feature extraction, for example, the target picture is input into backbone neural network for picture feature extraction to obtain an initial feature map. Then, the initial feature map is inputted to a neural network used for determining the above position offset information to obtain a feature map. The position offset information corresponding to the center point of each human body can be determined based on the feature map.

In implementation, after the initial feature map is processed by the neural network used for determining the above position offset information, a feature map of 80×60×2 may be acquired.

In the second step, a respective human face matching each human body is determined based on the determined predicted position information and the position information of the center point of each human face.

Here, the human face corresponding to the position of the center point closest to the position corresponding to the predicted position information is taken as a human face matching the human body.

In the third step, for a human body and a human face that are successfully matched with each other, whether the human body and the human face that are successfully matched with each other belong to a child is determined by using object type information corresponding to a center point of the human body that is successfully matched and object type information corresponding to a center point of the human face.

Here, when the object type information corresponding to the center point of the human body that is successfully matched indicates that a person to which the corresponding human body belongs is a child, or when the object type information corresponding to the center point of the human face that is successfully matched indicates that a person to which the corresponding human face belongs is a child, a person to which the successfully matched human body and human face belong is determined to be a child.

The prediction position information of the center point of the respective human face matching each human body can be determined by using the position offset information corresponding to the center point of the human body, and then the respective human face matching each human body can be determined by using the prediction position information. Child identification is performed by using a human body and a human face that are successfully matched, which can improve the accuracy rate of identification.

A human body or a human face may be not successfully matched due to occlusion or the like. In this case, for a human body that is not successfully matched, whether a person to which the center point of the human body belongs is a child is determined by using object type information corresponding to the center point of the human body. In a case where the object type information corresponding to the center point of the human body indicates a child, the person to which the human body belongs is determined to be a child.

For a human face that is not successfully matched, whether the person to which the center point of the human face belongs is a child is determined by using the object type information corresponding to the center point of the human face. In a case where the object type information corresponding to the center point of the human face indicates a child, the person to which the human face belongs is determined to be a child.

According to above, for a human body that is not successfully matched or a human face that is not successfully matched, child identification may be performed more accurately by using the object type information corresponding to the center point of itself.

While improving safety problems in the process of a child riding on a vehicle, a more comfortable and safe riding environment for the child may be provided by identifying status characteristic information of the child and adjusting a vehicle cabin environment in the vehicle cabin based on the status characteristic information.

The status characteristic information may include sleep status characteristic information, emotional status characteristic information, and the like. The emotional status characteristic information may include pleasure, crying, calm, and the like.

After determining the status characteristic information, the operation of adjusting the vehicle cabin environment in the vehicle cabin may be adjusting the light to a soft status or playing a lullaby or the like in a case where the status characteristic information indicates that the child is in a sleep status, setting the played music to a happy type music in a case where the status characteristic information indicates that the child is in a happy emotional status, or setting the played music to a soothing type music in a case where the status characteristic information indicates that the child is in a crying emotional state.

In some embodiments, whether the child is in a sleep status is determined by using the following steps.

In the first step, face sub-pictures of the child are intercepted from the target picture.

Here, the face sub-pictures of the child may be intercepted from the target picture by using the center point of the human face and the length information and the width information of the center point of the human face determined in the above embodiment.

The size of a picture used for performing sleep status identification and the number of pixels of the picture can be reduced by using the face sub-pictures. That is, data processing volume used for performing sleep status identification can be reduced, thereby improving the efficiency of sleep status identification.

In the second step, the left eye opening and closing status information of the child and the right eye opening and closing status information of the child are determined based on the face sub-pictures.

Here, the left eye opening and closing status information includes left eye invisibility, left eye visibility and opening, left eye visibility and closing. The right eye opening and closing status information includes right eye invisibility, right eye visibility and opening, right eye visibility and closing.

In the implementation, the face sub-pictures are inputted into a trained neural network, and nine types of left and right eye status information can be outputted through the processing of the neural network.

The above neural network may be composed of two fully coupled layers, and the input of the neural network is feature maps obtained by performing picture feature extraction on the face sub-pictures. The first-layer fully coupled layer converts the input feature maps into a K4-dimensional feature vector, and the second-layer fully coupled layer converts the K4-dimensional feature vector into a 9-dimensional vector for output, and then performs classification softmax processing. The status information corresponding to the dimension with the largest score output by the softmax is the last predicted status information.

In third step, the sleep status characteristic information of the child is determined based on the left eye opening and closing status information of the child and the right eye opening and closing status information of the child.

Here, the following sub-steps may be used to implement the above step.

An eye closure cumulative duration of the child is determined based on the left eye opening and closing status information and the right eye opening and closing status information corresponding to multiple successive frames of target pictures. The sleep status characteristic information is determined as a sleep status when the eye closure cumulative duration is greater than a preset threshold value. The sleep status characteristic information is determined as a non-sleep status when the eye closure cumulative duration is less than or equal to the preset threshold value.

As described above, the eye closure cumulative duration of the child is determined in combination with the status information of eye opening and closing of the left eye and right eye of the child, and then the relationship between the eye closure cumulative duration of the child and the preset threshold value is used, so that whether the child is in a sleep status can be determined accurately.

As can be seen from the above description, the status characteristic information further includes the emotional status characteristic information of the child, and as shown in FIG. 4, in some embodiments, the emotional status characteristic information of the child may be identified by using the following steps.

In step S410, face sub pictures of the child are intercepted from the target picture.

Here, the face sub-pictures of the child may be intercepted from the target picture by using the center point of the human face and the length information and width information of the center point of the human face determined in the above embodiment.

The size of a picture used for performing emotional status identification and the number of pixels of the picture can be reduced by using the face sub-pictures. That is, the data processing volume used for performing emotional status identification can be reduced, thereby improving the efficiency of the emotional status identification.

In step S420, an action of each of at least two organs of a human face represented by the face sub-picture is identified.

Here, the actions of the organs on the human face may include frowning, staring, raising corners of mouth, raising upper lip, lowering corners of mouth, and opening mouth.

Before the face sub-pictures are input to the trained neural network to perform the actions identification of the human face organs, in order to improve the efficiency and accuracy rate of the action identification performed by the neural network, in a possible embodiment, the picture preprocess may be performed on the face sub-pictures to obtain the processed face sub-pictures. The picture preprocess is used to perform key information enhancement process on the face sub-pictures. The processed face sub pictures are then input to the trained neural network for action identification.

In step S430, emotional status characteristic information of a human face represented by the face sub-pictures is determined based on the identified action of each organ.

Here, there is a certain correspondence relationship between the emotional status characteristic information and the action of the organ. For example, when the action of the organ is raising corners of mouth, the corresponding emotional status characteristic information is happy, and when the action of the organ is staring and opening mouth, the corresponding emotional status characteristic information is surprised.

In the implementation process, the operation that the emotional status characteristic information of the human face is determined based on the identified organ action may be determining the emotional status characteristic information of the human face represented by the face sub-pictures based on the identified action of each organ of the human face and the correspondence relationship between the preset action and the emotional status characteristic information.

In above step 420, the operation that the picture preprocess is performed on the face sub-pictures may be performed by using the following operations. The position information of the key points in the face sub-pictures is determined. A affine transformation is performed on the face sub-pictures based on the position information of the key points to obtain pictures that are transformed to front, which correspond to the face sub-pictures. The normalization process is performed on the pictures that are transformed to front to obtain the processed face sub-pictures.

The key points in the face sub-pictures may include, for example, eye corners, mouth corners, eyebrows, eyebrow tails, a nose, and the like. In the implementation, the key points in the face sub-pictures may be set according to requirements. The position information of the key point may be position coordinates of the key point in the face sub-pictures.

The operation that the affine transformation is performed on the face sub-pictures based on the position information of the key points may be performed by using the following steps. The transformation matrix is determined firstly based on the position information of the key points and the pre-stored preset position information of the target key points, and the transformation matrix is used to represent the transformation relationship between the position information of each key point in the face sub-picture and the preset position information of the target key point matching the key point. Then, the affine transformation is performed on the face sub-pictures based on the transformation matrix.

The transformation matrix being determined based on the position information of the key points and the pre-stored preset position information of the target key point may be calculated according to the following formula (1):

$$[ {x}^{′} {y}^{′} 1 ] = [ x y 1 ] \cdot [ \begin{matrix}{a}_{11} & {a}_{12} & 0 \\ {a}_{12} & {a}_{22} & 0 \\ {x}_{0} & {y}_{0} & 1\end{matrix} ] \qquad formula ( 1 )$$

Where, x′ and y′ represent the horizontal coordinate and vertical coordinate of the pre-stored target key point, x and y represent the horizontal coordinate and vertical coordinate of the key point, and

$$[ \begin{matrix}{a}_{11} & {a}_{12} & 0 \\ {a}_{12} & {a}_{22} & 0 \\ {x}_{0} & {y}_{0} & 1\end{matrix} ]$$

represents the transformation matrix.

The operation that the affine transformation is performed on the face sub-pictures based on the transformation matrix may be performed according to the following steps. The coordinates of each pixel point in the face sub-pictures are determined firstly, then the coordinates of each pixel point in the face sub-pictures may be substituted into the above formula to determine the transformed coordinates corresponding to each pixel point, and the pictures that are transformed to front corresponding to the face sub-pictures are determined based on the transformed coordinates corresponding to each pixel point.

By performing the affine transformation on the face sub-pictures, the face sub-pictures with different orientations in the face sub-pictures may be transformed to the face sub-pictures with a front orientation, and action identification is performed based on the pictures that are transformed to front corresponding to the face sub-pictures, which may improve the accuracy rate of the action identification.

After the affine transformation is performed on the face sub-pictures based on the position information of the key points to obtain the pictures that are transformed to front corresponding to the face sub-pictures, the picture cut may be performed on the pictures that are transformed to front based on the position information of the key points to obtain the pictures after cutting, and then normalization process may be performed on the picture after cutting.

As described above, the actions of the organs of the human face are identified firstly, and then the expression status corresponding to the human face is determined based on the identified actions. Since the relationship between the actions of the organs of the human face and the expression status of the human face exists objectively, in this manner, the user does not need to make a subjective definition of the expression status for the face sub-pictures. In addition, since the actions of the organs of the human face may focus on certain specific human face features, comparing with identifying expression status directly, identifying expression status by identifying actions of the organs of the face sub-pictures may improve the accuracy rate. Therefore, the present embodiment improves the accuracy rate of human face expression identification.

In some embodiments, the above step of identifying the action of each of at least two organs of the human face represented by the face sub-pictures is performed by a neural network used for performing action identification. The neural network used for performing action identification includes a backbone network and at least two classification branch networks, each classification branch network being used for identifying an action of one organ of a human face.

The operation of the action of each of at least two organs of the human face represented by the face sub-pictures is identified may include the following steps.

In the first step, feature extraction is performed on the face sub-pictures by using the backbone network to obtain feature maps of the face sub-pictures.

In the second step, action identification is performed according to the feature maps of the face sub-pictures by using each classification branch network to obtain an occurrence probability of an action that can be identified by each classification branch network.

In third step, the action whose occurrence probability is greater than a preset probability is determined as the action of the organ of the human face represented by the face sub-pictures.

When the human face represented by the face sub-pictures includes actions of a plurality of organs, the actions of the plurality of organs corresponding to the face sub-pictures may be identified at the same time by the above method. In addition, the action of the corresponding organ is identified by each classification branch network. Since the picture characteristic corresponding to the action of a specific organ may be focused when each classification branch network is trained, in this way, the identification accuracy rate of the trained classification branch network is higher, thereby making the accuracy rate of the emotional status identification higher.

Corresponding to the above-method for detecting child status, the present disclosure further provides an apparatus for detecting child status. The apparatus is applied to a terminal device or a server that detecting state and safety of a child, and each module can implement the same method steps and obtain the same beneficial effects as those in the above method. Therefore, the present disclosure is not repeated for the same part thereof.

As shown in FIG. 5, in some embodiments, the apparatus provided by the present disclosure includes a picture acquisition module 510, a child identification module 520, a position determination module 530 and an alarm module 540.

The picture acquisition module 510 is configured to acquire a target picture of an interior of a vehicle cabin.

The child identification module 520 is configured to identify a child in the target picture.

The position determination module 530 is configured to determine, based on position information of the child, whether the child is located on a rear seat in the vehicle cabin;

The alarm module 540 is configured to issue an alarm in a case where the child is not located on the rear seat in the vehicle cabin.

In some embodiments, the position determination module 530 is further configured to determine, based on the position information of the child and position information of a safety seat in the target picture, whether the child is located on the safety seat.

An alarm module 540 is configured to issue an alarm in response to a movement speed of the vehicle cabin being greater than a preset value in a case where the child is not on the safety seat.

In some embodiments, the apparatus for detecting child status further includes a safety seat identification module, which is configured to identify a safety seat in the target picture.

The above alarm module 540 is further configured to issue an alarm in response to a movement speed of the vehicle cabin being greater than a preset value in a case of determining that there is no safety seat in the vehicle cabin.

In some embodiments, the child identification module 520 is further configured to perform the following operations.

Status characteristic information of the child is identified.

A vehicle cabin environment in the vehicle cabin is adjusted based on the status characteristic information.

In some embodiments, the child identification module 520, when identifying the child in the target picture, is configured to perform the following operations.

Object information of various objects in the target picture is determined based on the target picture. Object information of one object includes center point information of the object and object type information corresponding to a center point of the object.

The child in the target picture is determined based on the determined object information of various objects.

In some embodiments, the child identification module 520, when determining object information of various objects in the target picture based on the target picture, is configured to perform the following operations.

Feature extraction is performed on the target picture to obtain a first feature map corresponding to the target picture.

A response value of each feature point in the first feature map being a center point of the object is acquired from a first preset channel of the first feature map.

The first feature map is divided into a plurality of sub-regions, and a maximum response value in each sub-region and a feature point corresponding to the maximum response value are determined.

A target feature point of a maximum response value greater than a preset threshold value is taken as the center point of the object, and position information of the center point of the object is determined based on a position index of the target feature point in the first feature map.

In some embodiments, the object information further includes length information and width information of an object corresponding to the center point of the object. The child identification module 520 is further configured to perform the following operations.

Length information of an object taking the target feature point as the center point of the object is acquired at a position corresponding to the position index of the target feature point from a second preset channel of the first feature map.

Width information of an object taking the target feature point as the center point of the object is acquired from a position corresponding to the position index of the target feature point form a third preset channel of the first feature map.

In some embodiments, the child identification module 520, when determining the object information of various objects in the target picture based on the target picture, is further configured to perform the following operations.

Feature extraction is performed on the target picture to obtain a second feature map corresponding to the target picture.

A position index of the target feature point in the second feature map is determined based on the position index of the target feature point in the first feature map.

Object type information corresponding to the target feature point is acquired at a position corresponding to the position index of the target feature point in the second feature map.

In some embodiments, the object includes a human face and a human body.

When the child identification module 520 determines the child in the target picture based on the determined object information of the various objects, the child identification module 520 is configured to perform the following operations.

Predicted position information of a center point of a respective human face matching each human body is determined based on position offset information corresponding to the center point of each human body. A human body matches a human face belonging to a same person.

A respective human face matching each human body is determined based on the determined predicted position information and position information of a center point of each human face.

For a human body and a human face that are successfully matched, whether the human body and the human face that are successfully matched with each other belong to a child is determined by using object type information corresponding to a center point of the human body that is successfully matched and object type information corresponding to a center point of the human face.

In some embodiments, the child identification module 520 is further configured to perform the following operations.

For a human body that is not successfully matched, whether a person to which a central point of the human body belongs is a child is determined by using object type information corresponding to the central point of the human body.

For a face that is not successfully matched, whether a person to which the center point of the human face belongs is a child is determined by using object type information corresponding to the center point of the human face.

In some embodiments, the status characteristic information includes sleep status characteristic information of the child.

The child identification module 520 is configured to perform the following operations.

Face sub-pictures of the child are intercepted from the target picture.

Left eye opening and closing status information of the child and right eye opening and closing status information of the child are determined based on the face sub-pictures.

The sleep status characteristic information of the child is determined based on the left eye opening and closing status information of the child and the right eye opening and closing status information of the child.

In some embodiments, the child identification module 520, when determining the sleep status characteristic information of the child based on the left eye opening and closing status information of the child and the right eye opening and closing status information of the child, is configured to perform the following operations.

An eye closure cumulative duration of the child is determined based on the left eye opening and closing status information and the right eye opening and closing status information corresponding to multiple successive frames of target pictures.

The sleep status characteristic information is determined as a sleep status when the eye closure cumulative duration is greater than a preset threshold value.

The sleep status characteristic information is determined as a non-sleep status when the eye closure cumulative duration is less than or equal to the preset threshold value.

In some embodiments, the status characteristic information includes emotional status characteristic information of the child.

The child identification module 520 is configured to perform the following operations.

Face sub-pictures of the child are intercepted from the target picture.

An action of each of at least two organs of a human face represented by the face sub-pictures is identified.

Emotional status characteristic information of a human face represented by the face sub-pictures is determined based on the identified action of each organ.

In some embodiments, the actions of organs of the human face include: frowning, staring, raising corners of mouth, raising upper lip, lowering corners of mouth, and opening mouth.

In some embodiments, the step of identifying the action of each of at least two organs of the human face represented by the face sub-pictures is performed by a neural network used for performing action identification, the neural network used for performing action identification including a backbone network and at least two classification branch networks, each classification branch network being used for identifying an action of one organ of a human face.

The operation of identifying the action of each of at least two organs of the human face represented by the face sub-pictures includes the following operations.

Feature extraction is performed on the face sub-pictures by using the backbone network to obtain feature maps of the face sub-pictures.

Action identification is performed according to the feature maps of the face sub-pictures by using each classification branch network to obtain an occurrence probability of an action that can be identified by each classification branch network.

An action whose occurrence probability is greater than a preset probability is determined as the action of the organ of the human face represented by the face sub-pictures.

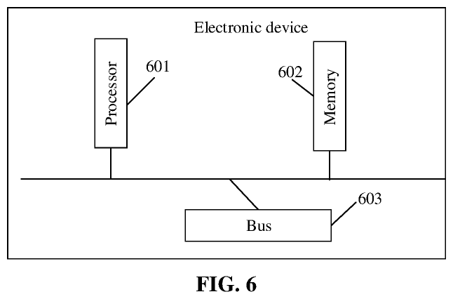

The embodiments of the present disclosure disclose an electronic device. As shown in FIG. 6, in some embodiments, the electronic device includes a processor 601, a memory 602 and a bus 603. The memory 602 stores machine-readable instructions executable by the processor 601. The processor communicates with the storage medium through the bus when the electronic device is operating.

When the machine-readable instructions are executed by the processor 601, the following steps of the method for detecting child status are performed.

A target picture of an interior of a vehicle cabin is acquired.

A child in the target picture is identified.

Whether the child is located on a rear seat in the vehicle cabin is determined based on position information of the child.

In a case where the child is not located on the rear seat in the vehicle cabin, an alarm is issued.

In addition, when the machine-readable instructions are executed by the processor 601, the method contents in any of the embodiments described in the method section above may be executed, and details are not described herein.

In addition, the embodiments of the present disclosure further provide a computer-readable storage medium on which computer programs are stored. When the computer programs are executed by a processor, the steps of the method described in the method embodiments described above are performed.

The embodiments of the present disclosure further provide a computer program product corresponding to the above-described method and apparatus. The computer program product includes a computer-readable storage medium storing program code. The instructions included in the program code may be used to perform the method steps in the above method embodiments, and the implementation may refer to the method embodiments, and details are not described herein.

The above description of the various embodiments tends to emphasize differences between the various embodiments, and the same or similar parts may be referred to each other. For brevity, details are not described herein.

Those skilled in the art will clearly understand that for the convenience and brevity of the description, reference may be made to the corresponding process in the method embodiment for the operation process of the system and apparatus described above, and details are not described herein. In the several embodiments provided by the present disclosure, it should be understood that the disclosed systems, apparatus, and methods may be implemented in other ways. The apparatus embodiments described above are merely illustrative. For example, the partitioning of the module is merely a logical function partitioning, and in practice, the partitioning of the module may be implemented in another partitioning manner. For another example, a plurality of modules or components may be combined or integrated into another system, or some features may be ignored or not performed. Alternatively, the shown or discussed coupling or direct coupling or communication connection to one another may be via some communication interface, indirect coupling or communication connection of devices or modules may be in electrical, mechanical or other form.

The modules described as separate components may or may not be physically separate, and the components displayed as modules may or may not be physical units, i.e. may be located in one place, or may be distributed over a plurality of network units. Some or all of the units may be selected according to actual needs to implement the purpose of the present embodiment solution.

In addition, each functional unit in various embodiments of the present disclosure may be integrated in one processing unit, or each unit may be physically present alone, or two or more units may be integrated in one unit.

The functions may be stored in a processor executable non-volatile computer readable storage medium if implemented in the form of a software functional unit and sold or used as an independent product. Based on such an understanding, the technical solutions of the present disclosure essentially, or part of a contribution to the prior art, or part of the technical solutions, may be embodied in the form of a software product stored in a storage medium, including several instructions for causing a computer device, which may be a personal computer, a server, a network device, or the like, to perform all or part of the steps of the methods described in the various embodiments of the present disclosure. The above storage medium includes a USB flash drive, a removable hard disk, a ROM, a RAM, a magnetic disk, an optical disk, or any other medium that can store program code.

The above is merely the embodiments of the present disclosure, but the scope of protection of the present disclosure is not limited thereto. Any variation or replacement readily contemplated by those skilled in the art within the scope of the present disclosure should be included within the scope of protection of the present disclosure. Accordingly, the scope of protection of the present disclosure shall be governed by the scope of protection of the claims.

### INDUSTRIAL PRACTICALITY

According to the present disclosure, whether a child in a vehicle cabin is located on a rear seat is determined by identifying the child in the vehicle cabin and the position of the child, and an alarm is issued in a case where the child is not located on the rear seat, thereby effectively improving an accuracy rate of safety status identification when the child is riding on a vehicle, and improving safety of the child riding on a vehicle.

1. A method for detecting child status, comprising:
acquiring a target picture of an interior of a vehicle cabin;
identifying a child in the target picture;
determining, based on position information of the child, whether the child is located on a rear seat in the vehicle cabin; and
in a case where the child is not located on the rear seat in the vehicle cabin, issuing an alarm.

2. The method for detecting child status of claim 1, further comprising:
determining, based on the position information of the child and position information of a safety seat in the target picture, whether the child is located on the safety seat; and
in a case where the child is not located on the safety seat, issuing an alarm in response to a movement speed of the vehicle cabin being greater than a preset value.

3. The method for detecting child status of claim 1, further comprising:
identifying a safety seat in the target picture; and
in a case of determining that there is no safety seat in the vehicle cabin, issuing an alarm in response to a movement speed of the vehicle cabin being greater than a preset value.

4. The method for detecting child status of claim 1, wherein identifying the child in the target picture further comprises:
identifying status characteristic information of the child; and
adjusting a vehicle cabin environment in the vehicle cabin based on the status characteristic information.

5. The method for detecting child status of claim 1, wherein identifying the child in the target picture comprises:
determining object information of various objects in the target picture based on the target picture, wherein object information of one object comprises center point information of the object and object type information corresponding to a center point of the object; and
determining the child in the target picture based on the determined object information of the various objects.

6. The method for detecting child status of claim 5, wherein determining the object information of various objects in the target picture based on the target picture comprises:
performing feature extraction on the target picture to obtain a first feature map corresponding to the target picture;
acquiring, from a first preset channel of the first feature map, a response value of each feature point in the first feature map being a center point of the object;
dividing the first feature map into a plurality of sub-regions, and determining a maximum response value in each sub-region and a feature point corresponding to the maximum response value; and
taking a target feature point of a maximum response value greater than a preset threshold value as the center point of the object; and
determining position information of the center point of the object based on a position index of the target feature point in the first feature map.

7. The method for detecting child status of claim 6, wherein the object information further comprises length information and width information of an object corresponding to the center point of the object and determining the object information of various objects in the target picture based on the target picture further comprises:
acquiring, from a second preset channel of the first feature map, at a position corresponding to the position index of the target feature point, length information of an object taking the target feature point as the center point of the object; and
acquiring, from a third preset channel of the first feature map, at the position corresponding to the position index of the target feature point, width information of an object taking the target feature point as the center point of the object.

8. The method for detecting child status of claim 6, wherein determining the object information of various objects in the target picture based on the target picture further comprises:
performing feature extraction on the target picture to obtain a second feature map corresponding to the target picture;
determining a position index of the target feature point in the second feature map based on the position index of the target feature point in the first feature map; and
acquiring object type information corresponding to the target feature point at a position corresponding to the position index of the target feature point in the second feature map.

9. The method for detecting child status of claim 5, wherein the object comprises a human face and a human body;
wherein determining the child in the target picture based on the determined object information of the various objects comprises:
determining, based on position offset information corresponding to a center point of each human body, predicted position information of a center point of a respective human face matching each human body respectively, wherein a human body matches a human face belonging to a same person;
determining, based on the determined predicted position information and position information of a center point of each human face, a respective human face matching each human body; and
for a human body and a human face that are successfully matched, determining, by using object type information corresponding to a center point of the human body and object type information corresponding to a center point of the human face, whether the human body and the human face that are successfully matched belong to a child.

10. The method for detecting child status of claim 9, further comprising:
for a human body that is not successfully matched, determining, by using object type information corresponding to a central point of the human body, whether a person to which the central point of the human body belongs is a child; and
for a human face that is not successfully matched, determining, by using object type information corresponding to a center point of the human face, whether a person to which the center point of the human face belongs is a child.

11. The method for detecting child status of claim 4, wherein the status characteristic information comprises sleep status characteristic information of the child;
wherein identifying the status characteristic information of the child comprises:
intercepting face sub-pictures of the child from the target picture;
determining left eye opening and closing status information of the child and right eye opening and closing status information of the child based on the face sub-pictures; and
determining the sleep status characteristic information of the child based on the left eye opening and closing status information of the child and the right eye opening and closing status information of the child.

12. The method for detecting child status of claim 11, wherein determining the sleep status characteristic information of the child based on the left eye opening and closing status information of the child and the right eye opening and closing status information of the child comprises:
determining an eye closure cumulative duration of the child based on the left eye opening and closing status information and the right eye opening and closing status information corresponding to multiple successive frames of target pictures;
determining the sleep status characteristic information as a sleep status when the eye closure cumulative duration is greater than a preset threshold value; and
determining the sleep status characteristic information as a non-sleep status when the eye closure cumulative duration is less than or equal to the preset threshold value.

13. The method for detecting child status of claim 4, wherein the status characteristic information comprises emotional status characteristic information of the child;
wherein identifying the status characteristic information of the child comprises:
intercepting face sub-pictures of the child from the target picture;
identifying an action of each of at least two organs of a human face represented by the face sub-pictures; and
determining, based on the identified action of each organ, emotional status characteristic information of a human face represented by the face sub-pictures.

14. The method for detecting child status of claim 13, wherein actions of organs of the human face comprise:
frowning, staring, raising corners of mouth, raising upper lip, lowering corners of mouth, and opening mouth.

15. The method for detecting child status of claim 13, wherein the operation of identifying the action of each of at least two organs of the human face represented by the face sub-pictures is performed by a neural network used for performing action identification, the neural network used for performing action identification comprising a backbone network and at least two classification branch networks, each classification branch network being used for identifying an action of one organ of a human face;
wherein identifying the action of each of at least two organs of the human face represented by the face sub-pictures comprises:
performing feature extraction on the face sub-pictures by using the backbone network to obtain feature maps of the face sub-pictures;
performing action identification according to the feature maps of the face sub-pictures by using each classification branch network to obtain an occurrence probability of an action that is able to be identified by each classification branch network; and
determining an action whose occurrence probability is greater than a preset probability as the action of the organ of the human face represented by the face sub-pictures.

16. An electronic device, comprising a processor, a storage medium, and a bus, wherein the storage medium stores machine-readable instructions executable by the processor, the processor communicates with the storage medium through the bus when the electronic device is operating, and the processor executes the machine-readable instructions to perform following operations:
acquiring a target picture of an interior of a vehicle cabin;
identifying a child in the target picture;
determining, based on position information of the child, whether the child is located on a rear seat in the vehicle cabin; and
in a case where the child is not located on the rear seat in the vehicle cabin, issuing an alarm.

17. The electronic device of claim 16, wherein the operations further comprises:
determining, based on the position information of the child and position information of a safety seat in the target picture, whether the child is located on the safety seat; and
in a case where the child is not located on the safety seat, issuing an alarm in response to a movement speed of the vehicle cabin being greater than a preset value.

18. The electronic device of claim 16, wherein the operations further comprises:
identifying a safety seat in the target picture; and
in a case of determining that there is no safety seat in the vehicle cabin, issuing an alarm in response to a movement speed of the vehicle cabin being greater than a preset value.

19. The electronic device of claim 16, wherein identifying the child in the target picture further comprises:
identifying status characteristic information of the child; and
adjusting a vehicle cabin environment in the vehicle cabin based on the status characteristic information.

20. A non-transitory computer-readable storage medium on which computer programs are stored, wherein the computer programs are executed by a processor to perform:
acquiring a target picture of an interior of a vehicle cabin;
identifying a child in the target picture;
determining, based on position information of the child, whether the child is located on a rear seat in the vehicle cabin; and
in a case where the child is not located on the rear seat in the vehicle cabin, issuing an alarm.
